(19) United States
(12) Patent Application Publication
(10) Pub. No.: US 2014/0161309 A1
(43) Pub. Date: Jun. 12, 2014

(54) GESTURE RECOGNIZING DEVICE AND METHOD FOR RECOGNIZING A GESTURE

(71) Applicant: CHUNGHWA PICTURE TUBES, LTD., Padeh City (TW)

(72) Inventors: Chih-Yin CHIANG, Nantou City (TW); Tzu-Hsuan HUANG, Taipei City (TW); Che-Wei CHANG, DAXI TOWNSHIP (TW)

(73) Assignee: CHUNGHWA PICTURE TUBES, LTD., Padeh City (TW)

(21) Appl. No.: 13/887,980

(22) Filed: May 6, 2013

(30) Foreign Application Priority Data
Dec. 7, 2012 (TW) 101146064

(51) Int. Cl. G06F 3/01; G06K 9/00

(52) U.S. Cl. CPC G06F 3/017; G06K 9/00355
USPC 382/103

(57) ABSTRACT

A gesture recognizing device includes an image processing module. The image processing module is adapted to process an image and includes a skin color detection unit adapted to determine whether the area of a skin color of the image is larger than a threshold value; a feature detection unit electrically connected to the skin color detection unit and adapted to determine a hand image of the image; and an edge detection unit electrically connected to the feature detection unit and adapted to determine a mass center coordinate, the number of fingertips and coordinate locations of fingertips of the hand image.

### CROSS-REFERENCE TO RELATED APPLICATION

This application claims the benefit of Taiwan Patent Application No. 101146064, filed on Dec. 7, 2012, which is hereby incorporated by reference for all purposes as if fully set forth herein.

### BACKGROUND OF THE INVENTION

1. Field of Invention

This invention relates to a gesture recognizing device and a method for recognizing a gesture, and more particularly to a. gesture recognizing device using an image processing technology, and a method for recognizing a gesture by using the above-mentioned device.

2. Related Art

According to the requirement of a man-machine interface system, the user wishes that the operation processes of the man-machine interface system can be simpler to directly use the man-machine interface system. The man-machine interface system can include four operation modes of: keyboard control, mouse control, touch control and remote control. The operation modes of the keyboard control is suitable for inputting characters, but current display interfaces are mostly graphic display interfaces. Thus, it is inconvenient to use the operation modes of the keyboard control. Although the operation mode of the mouse control or the remote control can provide good convenience, the user operates the mouse control or the remote control by necessarily using an external device. Moreover, the control distance of the mouse control or the remote control is restricted. According to the restriction of the operation mode of the touch control, the user must operate the man-machine interface system by using fingers or touch pens on an area of the touch screen having the touch control function.

Recently, the man-machine interface system can include another operation mode of simulating a hand to a computer mouse. For example, Kinect man-machine interface system firstly traces a hand to get the hand coordinate. Then, the hand coordinate is linked to the coordinate of the system to simulate the hand to the computer mouse. If the user moves the hand forward (toward an image sensor), the corresponding commands of the click action of the computer mouse are generated. However, a hardwire structure of Kinect man-machine interface system includes a matrix type infrared-rays emitter, an infrared-rays camera, a visible-light camera, a matrix type microphone, a motor, etc. to have high hardwire cost. Although the hardwire structure of Kinect man-machine interface system can get the coordinate location on Z-axis precisely, in a real application the corresponding commands can be gotten only by knowing the relation between the forward movement and the backward movement of the hand.

Accordingly, there exists a need for a gesture recognizing device and method is capable of solving the above-mentioned problems, wherein the gesture recognizing device and method have both the freedom of the operation space and the hand operation.

### SUMMARY OF THE INVENTION

It is an objective of the present invention to overcome insufficient freedom of the recent operation space, and then to provide a method for recognizing a gesture is capable of solving the above-mentioned problems, wherein the gesture recognizing device and method have both the freedom of the operation space and the hand operation.

In order to achieve the objective, the present. invention provides a method for recognizing a gesture including the following steps of: providing an image; transforming a three-original-colors (RGB) drawing of the image to a gray-level image; determining a hand image of the image; and determining at least one of a mass center coordinate of the hand image, the number of fingertips and fingertip coordinates of the hand image.

In order to achieve the objective, the present invention further provides a gesture recognizing device including an image processing module. The image processing module is adapted to process an image and includes a skin color detection unit adapted to determine whether the area of a skin color of the image is larger than a threshold value; a feature detection unit electrically connected to the skin color detection unit and adapted to determine a hand image of the image; and an edge detection unit electrically connected to the feature detection unit and adapted to determine at least one of a mass center coordinate, the number of fingertips and fingertip coordinates of the hand image.

The gesture recognizing method and device of the present invention utilizes the skin color detection unit to determine the area of the skin color, utilizes the feature detection unit to determine the hand image, and utilizes the edge detection unit to determine the mass center coordinate, the number of the fingertips and the fingertip coordinates of the hand image. According to the movement variance (coordinate location variance) between the hand images, the number variance of the fingertips and the flex variance of the fingers, the image processing module does not need to recognize the whole picture of the image. Thus, the file capacity of a picture of the hand image of the present invention is smaller, the speed of the hand image recognition can be faster, and the control unit executes the actions corresponding to the variances. During the use, the operation space of the gesture recognizing method and device of the present invention is not restricted, and the user can freely operate and control the man-machine interface system.

In order to make the aforementioned and other objectives, features and advantages of the present invention comprehensible, embodiments are described in detail below with reference to the accompanying drawings,

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram showing the structure of a man-machine interface system having a gesture recognizing device according to an embodiment of the present invention;

FIG. 2 is a flow chart showing a method for recognizing a gesture according to an embodiment of the present invention;

FIG. 3 is a flow chart showing a step for detecting the skin color according to the present invention;

FIG. 4a is a photo of a recognized image having a three-original-colors (RGB) drawing according to the present invention;

FIG. 4b is a photo of the recognized image without a value parameter according to the present invention;

FIG. 4c is a schematic view of the recognized image of the present invention showing a gray-level image;

FIG. 4d is a schematic view of the recognized image of the present invention, wherein a selected hand image is shown on the gray-level image;

FIG. 4e is a schematic view of the recognized image of the present invention, wherein convex points, concave points and a mass center coordinate are shown on the gray-level image; and

FIG. 5 is a schematic view of a man-machine interface system of the present invention showing that a user uses the man-machine interface system.

The present invention will become more fully understood from the detailed description given herein below for illustration only, and thus are not imitative of the present invention, and wherein:

### DETAILED DESCRIPTION OF THE INVENTION

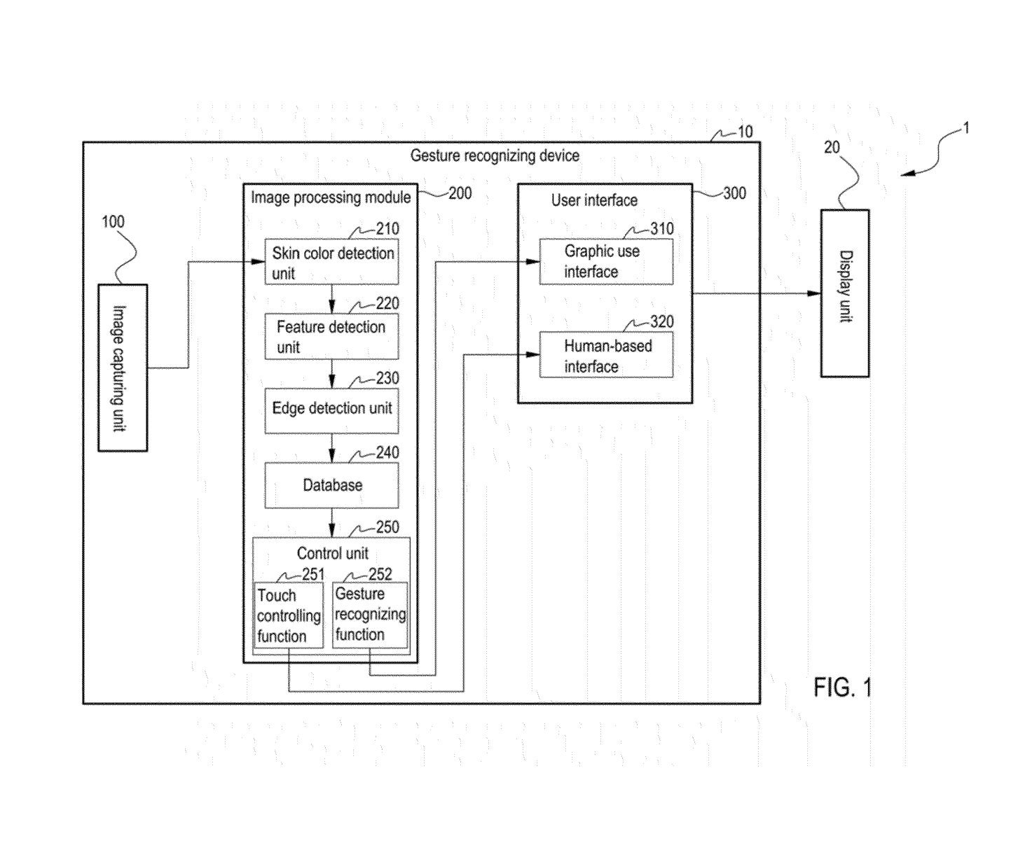

Referring to FIG. 1, it is a block diagram showing the structure of a man-machine interface system having a gesture recognizing device according to an embodiment of the present invention. The man-machine interface system 1 includes the gesture recognizing device 10 and a display unit 20. The gesture recognizing device 10 includes an image capturing unit 100, an image processing module 200 and a user interface 300. The image processing module 200 includes a skin color detection unit 210, a feature detection unit 220, an edge detection unit 230, a database 240 and a control unit 250. The image processing module 200 is electrically connected to the image capturing unit 100, and the user interface 300 is electrically connected to the image processing module 200.

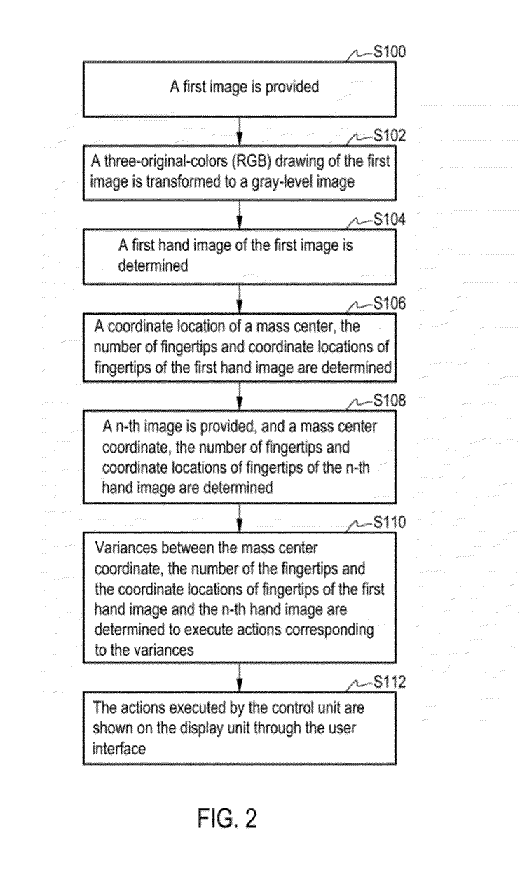

FIG. 2 is a flow chart showing a method for recognizing a gesture according to an embodiment of the present invention, and FIG. 1 is referred simultaneously. The method for recognizing a gesture includes the following steps:

In the step S100, a first image is provided. In this step, the image capturing unit 100 is electrically connected to the skin color detection unit 210. The image capturing unit 100 captures a first image, and then transmits the first image to the skin color detection unit 210. The image capturing unit 100 can be a camera or an image sensor.

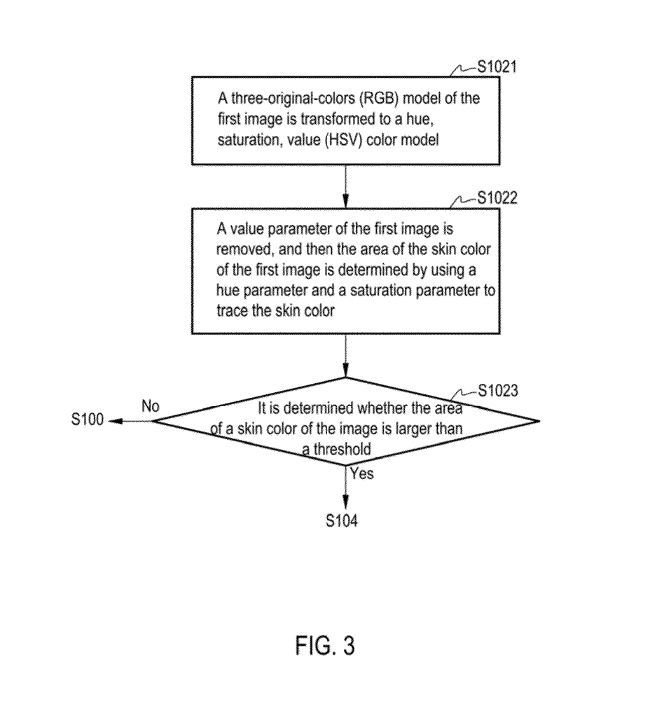

In the step S102, the skin color detection unit 210 executes a step for detecting a skin color, wherein a three-original-colors (RGB) drawing of the first image is transformed to a gray-level image. Referring to FIG. 3, the step for detecting the skin color includes the following steps:

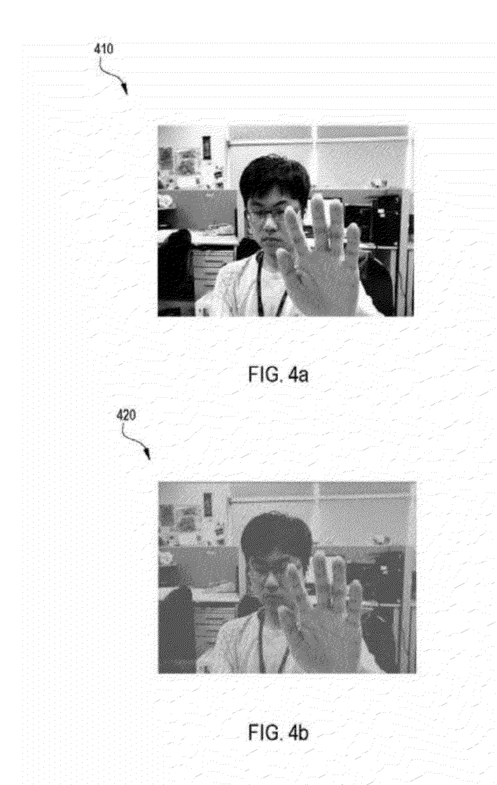

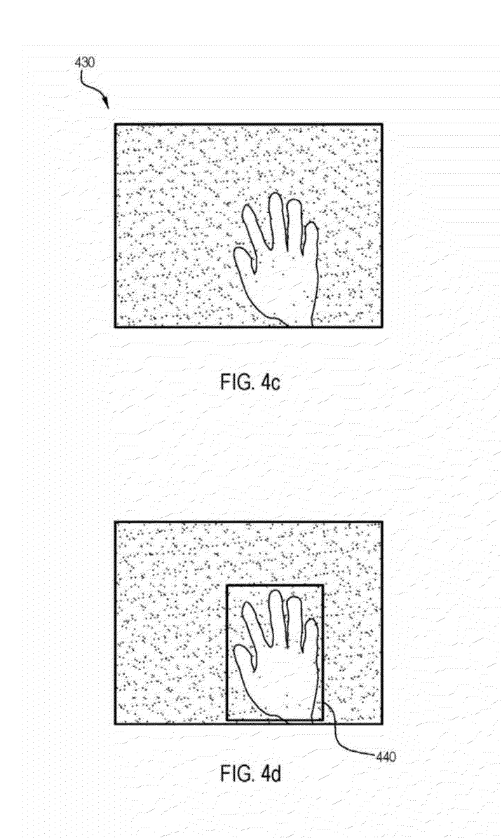

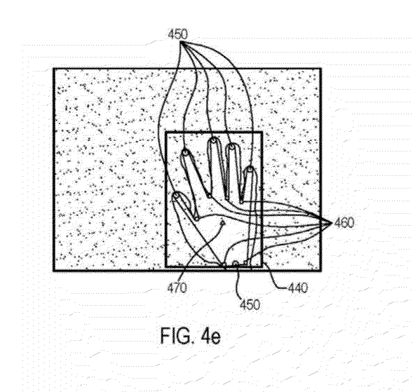

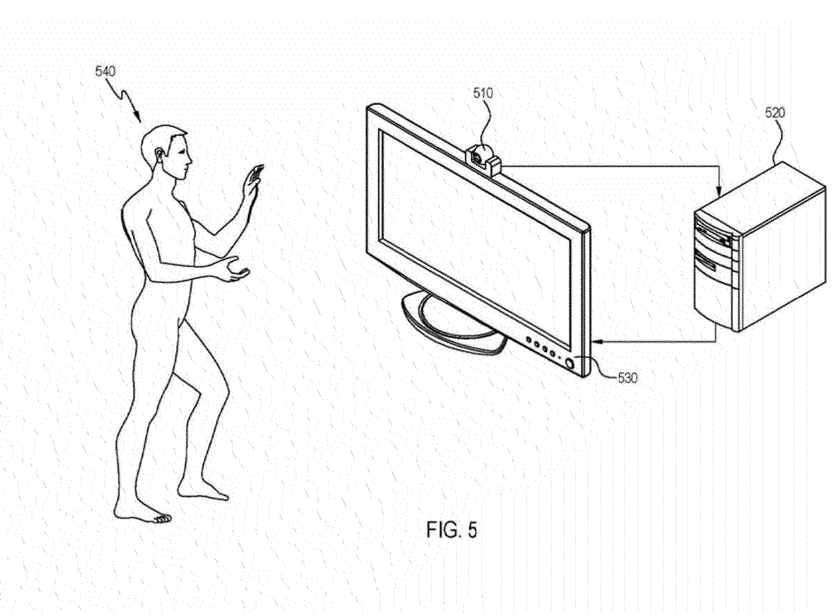

In the step S1021, a three-original-colors (RGB) model of the first image is transformed to a hue (i.e., tint), saturation (i.e., shade), value (i.e., tone and luminance) (HSV) color model. In this step, a frame which is received from the image capturing unit 100 to the skin color detection unit 210 is the first image 410. The first image 410 is primarily shown by the three-original-colors (RGB) model (shown in FIG. 4a). However, in order to determine the area of a skin color, the three-original-colors (RGB) model is transformed to the hue, saturation, value (HSV) color model to conveniently process the first image sequentially.

In the step S1022, a value parameter of the first image is removed, and then the area of the skin color of the first image is determined by using a hue parameter and a saturation parameter to trace the skin color. In this step, the skin color detection unit 210 firstly removes the value parameter of the first image 420 (shown in FIG. 4b) to reduce the effect of an external ambient light. By utilizing a palm which has no the black pigment, the hue parameter and the saturation parameter can be set to a range, a part of the first image 420 without the range is filtered, and the first image 420 is shown by gray-level to form the gray-level image 430 (shown in FIG. 4c). Then, another part of the first image 420 within the range is calculated to an area which is the area of the skin color of the first image. In the step S1023, it is determined whether the area of the skin color of the first image is larger than a threshold value. In this step, the skin color detection unit 210 determines whether the area of the skin color of the first image is larger than the threshold value or not. The threshold value is a predetermined ratio of the area of the skin color of the first image to the whole area of the first image. If the area of the skin color is smaller than the threshold value, the step S100 is executed again; in other words, the skin color detection unit 210 stops a detecting process, comes back to the original state, and waits for next image to repeatedly execute the detecting process. If the area of the skin color is larger than the threshold value, the skin color detection unit 210 transmits the gray-level image of the first image to the feature detection unit 220. When it is assumed that the whole area of the first image is 640×480, the area of the skin color of the first image must be larger than at least 300×200, wherein 300×200 is the above-mentioned threshold value.

In the step S104, the feature detection unit 220 executes a step for detecting a feature, whereby a first hand image of the first image is determined. In this step, when the feature detection unit 220 is electrically connected to the skin color detection unit 210 and receives the gray-level image of the first image from the skin color detection unit 210, the feature detection unit 220 utilizes the Harr algorithm to determine the first hand image of the first image. The Harr algorithm can calculate a plurality of vectors to set up a hand feature parameter model and further to get the corresponding sample feature parameter values respectively. During the recognition of a hand image, the feature detection unit 220 can capture a feature of each hand region of the hand image to calculate a region parameter eigenvalue corresponding each hand region. Then, the region parameter eigenvalue corresponding each hand region is compared with the sample feature parameter value to get the similarity between the hand region and the sample. IF the similarity is greater than a threshold value (e.g., the threshold value of the similarity is 95%), the hand image is determined and selected (shown in FIG. 4d). When the feature detection unit 220 determines the first image having the hand image, the feature detection unit 220 can transmit the hand image to the edge detection unit 230. IF a plurality of hand images are determined, the feature detection unit 220 only transmit the hand image having the most area, i.e., the first hand image 440.

In the step S106, the edge detection unit 230 executes a step for detecting an edge, whereby a mass center coordinate, the number of fingertips and fingertip coordinates of the first hand image are determined.

In this step, referring to FIG. 4e simultaneously, the edge detection unit 230 is electrically connected to the feature detection unit 220 and receives the first hand image from the feature detection unit 220. The edge detection unit 230 utilizes circular point patterns and square point patterns of a biggest convex polygon of the first hand image to be convex points 450 and concave points 460 respectively. The distances between the two adjacent concave points 460 and the convex point 450 therebetween can be calculated, thereby determining whether the fingertips (the convex points 450) are extended or retracted, and further acquiring the number of the fingertips and the fingertip coordinates. Or, the distance between the convex points 450 of the fingertip and the concave point 460 (which is adjacent to the convex points 450) located between two finger is calculated, e.g., the distance between the convex point of the fingertip of a forefinger and the concave point located between the forefinger and a middle finger is calculated. The edge detection unit 230 transmits the number of the fingertips and the fingertip coordinates of the first hand image 440 to the database 240.

In this step, the edge detection unit 230 determines the biggest convex polygon to calculate the area of the first hand image to acquire a triangular point pattern being the mass center coordinate 470. The edge detection unit 230 transmits the mass center coordinate 470 of the first hand image 440 to the database 240. In the step S108, a n-th image is provided, and a mass center coordinate, the number of fingertips and fingertip coordinates of the n-th hand image are determined. In this step, n is an integer being 2 or more than 2. The image capturing unit 100 captures the n-th image, and then transmits the n-th image to the skin color detection unit 210, as shown in the step S100. The skin color detection unit 210 executes a step for detecting a skin color of the n-th image, it is determined whether the area of the skin color of the n-th image is larger than a threshold value, and the skin color detection unit 210 transmits the gray-level image of the n-th image to the feature detection unit 220, as shown in the step S102. The feature detection unit 220 utilizes the Harr algorithm to determine the n-th hand image of the n-th image, and transmits the n-th hand image to the edge detection unit 230, as shown in the step S104. The edge detection unit 230 determines a mass center coordinate of the n-th hand image, the number of fingertips and fingertip coordinates of the n-th hand image, and transmits the number of the fingertips and the fingertip coordinates of the n-th hand image to the database 240, as shown in the step S106.

In the step S110, variances between a mass center coordinate, the number of the fingertips and fingertip coordinates of the first hand image and the n-th hand image are determined to execute actions corresponding to the variances. In this step, the control unit 250 is electrically connected to the database 240, and executes actions corresponding to the variances according to signals of the database 240.

For example, the first operating mode is that: the control unit 250 can determine a movement variance between the hand images according to the variance between the mass center coordinates of the first hand image and the n-th hand image (e.g. the second hand image), thereby executing the actions of touch controlling functions 251.

The second operating mode is that: the control unit 250 can determine a number variance of the fingertips according to the number of the fingertips of the first hand image or the n-th hand image (e.g. the second hand image), thereby executing the actions of gesture recognizing functions 252.

The third operating mode is that: the control unit 250 can determine a flex variance of the fingers according to the variance between fingertip coordinates of the first hand image and the n-th hand image (e.g. the second hand image), thereby executing the actions of gesture recognizing functions 252.

According to the above-mentioned first, second and third operating modes, the control unit 250 can select one of the three operating modes to be used, and also simultaneously select the three operating modes to be used mutually.

In the step S112, the actions executed by the control unit 250 are shown on the display unit 20 through the user interface 300. In this step, the user interface 300 includes a human-based interface 320 and a graphic use interface 310, and is electrically connected between the control unit 250 and the display unit 20. The human-based interface 320 is an output interface adapted to output the touch controlling functions 251. The graphic use interface 310 is an output interface adapted to output the gesture recognizing functions 252. The actions executed by the control unit 250 are shown on the display unit 20 through the human-based interface 320 and the graphic use interface 310.

For example, referring to FIG. 5, the gesture recognizing device of the present invention can replace the current computer mouse. The image capturing unit of the present invention can be a typical Web camera 510. The image processing module 520 of the present invention can be constituted by a chin set, processor (e.g. CPU or MPU), a control circuit, other auxiliary circuit, operation software, firmware, relative hardware and relative software. The display unit of the present invention can be a computer screen 530.

When a user 540 is located at the front of the Web camera 510 and the user 540 moves a hand leftward, a cursor shown on the computer screen 530 can be moved leftward by the image processing module 520. When the user 540 flexes a finger downward, an object selected by the cursor shown on the computer screen 530 can be executed to a “Click” action by the image processing module 520.

The gesture recognizing method and device of the present invention utilizes the skin color detection unit to determine the area of the skin color, utilizes the feature detection unit to determine the hand image, and utilizes the edge detection unit to determine the mass center coordinate, the number of the fingertips and the fingertip coordinates of the hand image. According to the movement variance (coordinate location variance) between the hand images, the number variance of the fingertips and the flex variance of the fingers, the image processing module does not need to recognize the whole picture of the image. Thus, the file capacity of a picture of the hand image of the present invention is smaller, the speed of the hand image recognition can be faster, and the control unit executes the actions corresponding to the variances. During the use, the operation space of the gesture recognizing method and device of the present invention is not restricted, and the user can freely operate and control the man-machine interface system.

To sum up, the implementation manners or embodiments of the technical solutions adopted by the present invention to solve the problems are merely illustrative, and are not intended to limit the scope of the present invention. Any equivalent variation or modification made without departing from the scope or spirit of the present invention shall fall within the appended claims of the present invention.

What is claimed is:

1. A method for recognizing a gesture comprising the following steps of:
providing a first image by an image capturing unit transforming a three-original-colors (RGB) drawing of the first image to a first gray-level image by a skin color detection unit;
determining a first hand image of the first image by a feature detection and
determining at least one of a mass center coordinate of the first hand image, the number of fingertips and fingertip coordinates of the first hand image by an edge detection unit.

2. The method as claimed in claim 1, wherein the step of transforming the three-original-colors (RGB) drawing of the first image to the first gray-level image further comprises the following steps of:
transforming a three-original-colors (RGB) model of the first image to a hue, saturation, value (HSV) color model;
removing a value parameter of the first image, then determining the area of the skin color of the first image by using a hue parameter and a saturation parameter to trace the skin color, and showing the first image by gray-level to form the first gray-level image; and
determining whether the area of the skin, color of the first image is larger than a threshold value.

3. The method as claimed in claim 2, wherein the threshold value is a predetermined ratio of the area of the kin color of the first image to the whole area of the first image.

4. The method as claimed in claim 1, further comprising the following steps of:
providing a second image;
transforming a three-original-colors (RGB) drawing of the second image to a second gray-level image;
determining a second hand image of the second image; and
determining at least one of a mass center coordinate, the number of fingertips and fingertip coordinates of the second hand image.

5. The method as claimed in claim 4, wherein the step of transforming the three-original-colors (RGB) drawing of the second image to the second gray-level image comprises the following steps of:
transforming a three-original-colors (RGB) model of the second image to a hue, saturation, value (HSV) color model;
removing a value parameter of the second image, then determining the area of the skin color of the second image by using a hue parameter and a saturation parameter to trace the skin color, and showing the second image by gray-level to form the second gray-level image; and
determining whether the area of the skin color of the second image is larger than a threshold value.

6. The method as claimed in claim 4, further comprising the following steps of determining the variance between the mass center coordinates of the first hand image and the second hand image, thereby executing actions corresponding the variance.

7. The method as claimed in claim 6, further comprising the following steps of: showing the actions on a display unit.

8. The method as claimed, in claim 4, wherein further comprising the following steps of determining the variance between the number of the fingertips of the first hand image or the second hand image, thereby executing actions corresponding the variance.

9. The method as claimed in claim 8, further comprising the following steps of showing the actions on a display unit

10. The method as claimed in claim 4, further comprising the following steps of: determining the variance between the fingertip coordinates of the first hand image and the second hand image, thereby executing actions corresponding the variance.

11. The method as claimed in claim 10, further comprising the following steps of: showing the actions on a display unit.

12. A gesture recognizing device comprising:
an image processing module adapted to process an image and comprising:
a skin color detection unit adapted to determine whether the area of a skin color of the image is larger than a threshold value;
a feature detection unit electrically connected to the skin color detection unit and adapted to determine a hand image of the image; and
an edge detection unit electrically connected to the feature detection unit and adapted to determine at least one of a mass center coordinate of the hand image, the number of fingertips and fingertip coordinates of the hand image.

13. The gesture recognizing device as claimed in claim 12, further comprising a database electrically connected to the edge detection unit for storing at least one of the mass center coordinate of the hand image, the number of the fingertips and the fingertip coordinates of the hand image.

14. The gesture recognizing device as claimed in claim 13, further comprising a control unit electrically connected to the database for determining a movement variance between the hand images according to the variance between the mass center coordinates.

15. The gesture recognizing device as claimed in claim 13, further comprising a control unit electrically connected to the database for determining a number variance of the fingertips according to the number of the fingertips.

16. The gesture recognizing device as claimed in claim 13, further comprising a control unit electrically connected to the database for determining a flex variance of the fingers according to the variance between the fingertip coordinates.
